(19) United States
(12) Patent Application Publication
(10) Pub. No.: US 2008/0268661 A1
(43) Pub. Date: Oct. 30, 2008

(54) Rotrary connector device

(75) Inventor: Takahiko Mitsui, Makinohara-shi (JP)

Correspondence Address: SUGHRUE-265550, 2100 PENNSYLVANIA AVE. NW, WASHINGTON, DC, 20037-3213, US

(73) Assignee: Yazaki Corporation, Tokyo (JP)

(21) Appl. No.: 11/643,805

(22) Filed: Dec. 22, 2006

(30) Foreign Application Priority Data
Feb. 17, 2006 (JP) 2006-040266

(51) Int. Cl. B62D 1/10; B60R 16/02

(52) U.S. Cl. 439/15; 403/230

(57) ABSTRACT

A rotary connector device includes a fixed cover, a rotary cover rotatable relative the fixed cover, a bottom cover fixed to the fixed cover, flat harnesses received within an annular space formed by these covers, and a rotary tube which passes through a hole formed through the bottom cover, and is fixed to the rotary cover. There is provided a dust prevention ring plate which is disposed in intimate contact with an outer peripheral surface of the rotary tube and an inner peripheral edge of the hole of the bottom cover. The ring plate is held between an inner peripheral wall of the rotary cover and an annular portion of the rotary tube. The ring plate is retainingly engaged with at least one of the rotary cover and the rotary tube against movement relative thereto in a direction of the periphery of the ring plate.

### BACKGROUND OF THE INVENTION

1. Field of the Invention

This invention relates to a rotary connector device which is provided, for example, around a steering of an automobile so as to effect a power supply, etc., while absorbing the rotation of the steering by bending and rotating a flat harness within a space formed by a fixed cover and a rotary cover.

2. Related Art

FIG. 8 shows one conventional rotary connector device (see JP-A-10-64646 Publication).

This rotary connector device 61 is provided in the vicinity of a steering (steering wheel) 62, and comprises an annular rotary cover 64 fixed to a steering shaft 63, an annular fixed cover 65 which is disposed around the outer periphery of the steering shaft 63, and is fixed to a combination switch 69, and a flexible flat harness 67 which is disposed in a generally spirally-wound condition within an annular (doughnut-shaped) space 66 formed by the two covers 64 and 65.

Rollers 68 are rotatably provided within the annular space 66, and the flat harness 67 is circumferentially disposed in contiguous relation to an inner peripheral wall of the rotary cover 64 at the inner side of the rollers 68, and is also circumferentially disposed in contiguous relation to an outer peripheral wall of the fixed cover 65 at the outer side of the rollers 68. One end of the flat harness 67 is connected at the rotary cover-side to an air bag device, a horn, etc., provided within the steering wheel, while the other end of the flat harness 67 is connected at the fixed cover-side to a power source, etc.

A recess portion 70 for storing dust 71 and others, intruding from the exterior into the inside of the covers 64 and 65 through a gap between the fixed cover 65 and the rotary cover 64 and other gaps, is provided at a lower end portion of a bottom wall of the fixed cover 65. Dust and so on are stored in the recess portion 70, and therefore the increase of a resistance to the rotation due to dust, etc., is suppressed, and also adverse effects of the dust, etc., on the bending/rotational motion of the flat harness 67 within the covers are suppressed.

However, in the above conventional rotary connector device 61, dust, etc., intrude into the inside of the covers, and therefore deposit on a sliding portion of the rotary cover 64, the flat harness 67, etc., before the dust, etc., are stored in the recess portion 70, and therefore there has been a fear that the increase of the resistance to the rotation, wear of the flat harness 67, etc., may occur. Furthermore, there has been a fear that besides dust, powder resulting from wear of the sliding portion of the rotary cover 64 intrudes into the inside of the covers, thus causing similar adverse effects as described above for the dust.

With respect to a similar rotary connector device (not shown), in the case where grease is coated on a sliding portion of a rotary cover, and two flat harnesses are used in a superposed manner, the grease intrudes into the inside of the covers, and is mixed with dust, etc., and therefore there has been a fear that the two flat harnesses are bonded together by the grease, so that a bending/rotational motion of the flat harnesses can not be effected smoothly.

### SUMMARY OF THE INVENTION

With the foregoing in view, it is an object of this invention to provide a rotary connector device in which dust, wear powder, grease, etc., are prevented from intruding into the inside of covers, thereby preventing wear of rotating portions, the increase of a resistance to the rotation, wear of a flat harness and the worsening of a bending/rotating ability of the flat harness.

The above object has been achieved by a rotary connector device of one aspect of the invention including a fixed cover, a rotary cover rotatable relative the fixed cover, a bottom cover fixed to the fixed cover, a flat harness received within an annular space formed by the fixed cover, the rotary cover and the bottom cover, and a rotary tube which passes through a hole formed through the bottom cover, and is fixed to the rotary cover; wherein a dust prevention ring plate is provided so as to be disposed in intimate contact with an outer peripheral surface of the rotary tube and an inner peripheral edge of the hole of the bottom cover.

With this construction, a gap between the bottom cover and the rotary tube is closed by the ring plate, and therefore dust, grease, wear powder, etc., are prevented from intruding into the inside of the covers through this gap. The bottom cover is fixed to the fixed cover, and the rotary tube is fixed to the rotary cover, and when the rotary cover and the rotary tube rotate relative to the fixed cover and the bottom cover, the flat harness (received in the space formed by the covers), while bent, rotates.

The rotary connector device of another aspect of the invention is characterized in that the ring plate is held between an inner peripheral wall of the rotary cover and an annular portion of the rotary tube.

With this construction, the ring plate is held between the rotary cover and the rotary tube in a direction of a wall thickness thereof (i.e., in a direction of an axis thereof), and therefore is fixed at least against movement in the axial direction, thereby preventing the shaking of the ring plate and the formation of a gap.

The rotary connector device of another aspect of the invention is characterized in that the ring plate is retainingly engaged with at least one of the rotary cover and the rotary tube against movement relative thereto in a direction of a periphery of the ring plate.

With this construction, the ring plate is properly positioned, and is fixed in the peripheral direction by the retaining means, and can rotate together with the rotary cover and the rotary tube. Examples of the retaining means include a projecting piece portion on the ring plate and a recess in the inner peripheral wall of the rotary cover, projections on the inner peripheral wall of the rotary cover and notches in the ring plate, and projections on the rotary tube and notches in the ring plate.

In the invention, the ring plate prevents dust, wear powder, grease, etc., from intruding into the inside of the covers, and therefore for example, when two flat harnesses are used, the two flat harnesses are positively prevented from being bonded together by the grease, so that the bending/rotational motion of the flat harnesses will not be adversely affected, and besides the flat harnesses are positively prevented from being worn by the dust and grease. Therefore, the reliability of power supply is enhanced, and besides the rotation operability can be maintained satisfactorily for a long period of time.

In the invention, the ring plate is held between the rotary cover and the rotary tube, and therefore the formation of a gap between the ring plate and the bottom cover is positively prevented. As a result, the advantageous effects of the invention are enhanced, and besides there is no need to provide any member for fixing the ring plate, and therefore the structure can be formed into a simplified low-cost design.

In the invention, the ring plate is retainingly engaged with the associated members, and therefore can rotate together with the rotary tube, and wear of the rotary tube and the ring plate, as well as the formation of a gap due to such wear, is prevented, and therefore the advantageous effects of the invention are enhanced.

### BRIEF DESCRIPTION OF THE DRAWINGS

FIG. 1 is an exploded, perspective view showing one preferred embodiment of a rotary connector device of the present invention;

FIG. 2 is an exploded, perspective view showing a rotary cover, rollers, a carrier and a ring plate of the rotary connector device as seen from the reverse side;

FIG. 3 is a vertical cross-sectional view of one embodiment of a rotary connector device of the invention in its assembled condition;

FIG. 4 is a vertical cross-sectional view of a second embodiment of a rotary connector device of the invention having a modified ring plate-supporting structure;

FIG. 5 is a vertical cross-sectional view of a third embodiment of a rotary connector device of the invention;

FIG. 6 is a vertical cross-sectional view of a fourth embodiment of a rotary connector device of the invention;

FIG. 7 is a vertical cross-sectional view of a fifth embodiment of a rotary connector device of the invention; and

FIG. 8 is a vertical cross-sectional view of one conventional rotary connector device.

### DETAILED DESCRIPTION OF THE PREFERRED EMBODIMENTS

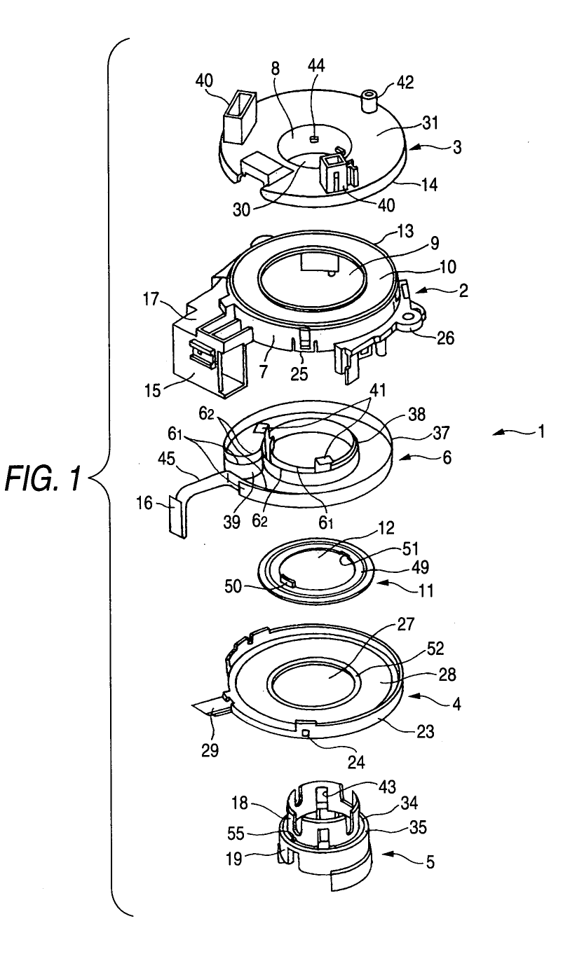

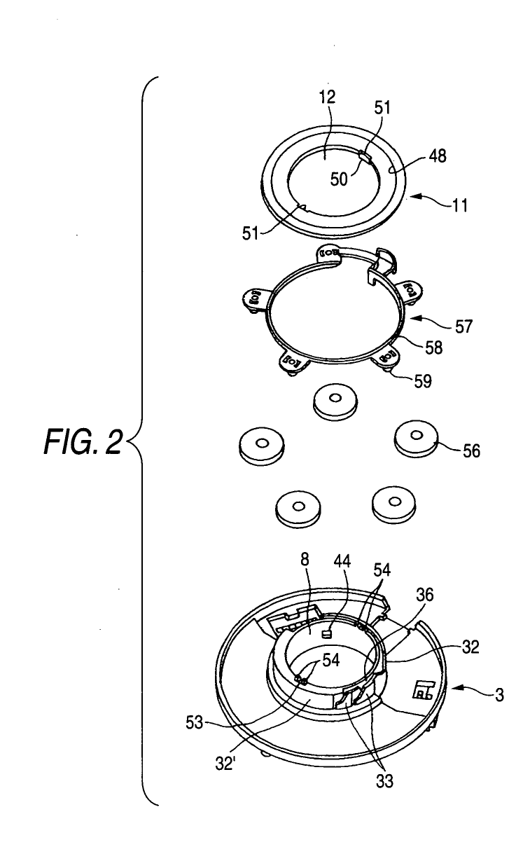

FIGS. 1 and 2 show one preferred embodiment of a rotary connector device of the present invention.

As shown in FIG. 1 (which is a view as seen from the front side), this rotary connector device 1 comprises a fixed cover (one cover) 2, a rotary cover (the other cover) 3, a bottom cover 4 engaged with the fixed cover 2, a rotary tube 5 which passes through a central hole 27 of the bottom cover 4, and rotates together with the rotary cover 3, two flexible flat harnesses 6 which are superposed together, and are received in a generally spirally-wound condition in an annular space formed by the fixed cover 2, the rotary cover 3 and the bottom cover 4, and a ring plate 11 which is engaged with the rotary tube 5, and is disposed in contiguous relation to an inner surface of the bottom cover 4. The rotary connector device 1 has a feature that the ring plate 11 prevents dust, wear powder, grease, etc., from intruding from an outer peripheral surface of the rotary tube 5 into the inside of the bottom cover 4.

Each of the above members 2, 3, 4, 5 and 11 is made of a synthetic resin. The fixed cover 2 includes a disk-like wall portion 10 having a central hole 9 of a large diameter, and an outer peripheral wall 7 integrally formed at an outer peripheral edge of the disk-like wall portion 10 and projecting perpendicularly therefrom. An annular rib 13 is formed on the disk-like wall portion 10, and is disposed near to the outer periphery thereof, and an inner surface of a distal end portion of an outer peripheral wall 14 of the upper-side rotary cover 3 is rotatably engaged with the rib 13.

A connector housing 15 is formed integrally on the outer peripheral wall 7 of the fixed cover 2, and a plurality of terminals (not shown) are provided within the connector housing 15, and proximal ends of the terminals are connected to one end portions 16 (which are outer peripheral portions) of the flat harnesses 6 (6, and 62) via a small circuit board (not shown) The connector housing 15 and the terminals jointly form a connector.

A recessed groove (not shown) is formed in a reverse surface of a horizontal support wall 17 of the fixed cover 2 extending from the connector housing 15. The fixed cover 2 has an annular wall portion which circumferentially extends in contiguous relation to the inner surface of the outer peripheral wall 7 in a manner to assume a double wall construction, and harness guide portions (not shown) are formed at the annular wall portion, and are arranged in a juxtaposed manner. A gap for the passage of the flat harnesses 6 is formed between the outer peripheral wall 7 and each of the harness guide portions, and the flat harnesses are introduced respectively via the harness guide portions into the space formed by the covers 2 and 3.

Retaining frame-like portions 25 for retaining engagement with a low-height outer peripheral wall 23 and retaining projections 24 of the lower-side bottom cover 4, as well as brackets 26 for being fixed by screws to a combination switch and soon (fixed structural members) disposed exteriorly of a steering shaft (not shown) of an automobile, are formed at the outer peripheral wall 7 of the fixed cover 2. A plate portion 29 for closing the recessed groove (not shown) of the support wall 17 of the fixed cover 2 is formed on and extends from an outer peripheral edge of a disk-like wall portion 28 of the bottom cover 4, the disk-like wall portion 28 having a central hole 27.

The rotary cover 3 includes a disk-like wall portion 31 having a central hole 30 of a small diameter, the outer peripheral wall 14 of a small height formed at an outer peripheral edge of the disk-like wall portion 31 and projecting perpendicularly therefrom, and an inner peripheral wall 8 formed at and projecting long perpendicularly from an inner peripheral edge of the hole 30 into a tubular shape. The rotary cover 3 further includes a semi-annular wall portion 32 (FIG. 2) circumferentially extending in contiguous relation to the outer peripheral surface of the inner peripheral wall 8, and two harness guide portions 33 which are formed adjacent to the semi-annular wall portion 32, and are juxtaposed to each other.

A gap 36 for the passage of the two flat harnesses 6 therethrough is formed between the inner peripheral wall 8 and semi-annular wall portion 32 (FIG. 2) of the rotary cover 3. Inner peripheral portions (inner portions) 38 of the two flat harnesses 6 (FIG. 1) are passed through the gap 36, and are introduced respectively via the guide portions 33 into the inside of the covers. The flat harnesses 6 are reversed with respect to their inner and outer surfaces by their respective turned-back portions 39 lying between the inner peripheral portions 38 and outer peripheral portions 37.

Connector housings 40 (FIG. 1) are formed integrally on the disk-like wall portion 31 of the rotary cover 3, and a plurality of terminals (not shown) are provided within each connector housing 40, and the terminals of the connector housings 40 are connected to the other end portions 41 of the respective flat harnesses 6 via respective circuit boards (not shown). Each circuit board is covered with a small sub-cover (not shown), and is disposed between the disk-like wall portion 31 of the rotary cover 3 and this sub-cover, and thus is protected for insulating purposes. The connector housing 40 and the terminals jointly form a connector.

A connecting pin 42 for a steering wheel (rotary member) of the automobile is formed on the disk-like wall portion 31 of the rotary cover 3. Retaining projections 44 for engagement with respective retaining frame-like portions 43 of the rotary tube 5 are formed on the inner peripheral surface of the inner peripheral wall 8 of the rotary cover 3. The rotary tube 5 is also called a turn canceller, and is provided around the outer periphery of the steering shaft (not shown), and rotates together with the rotary cover 3. In a mounted or assembled condition of the rotary connector device, the rotary cover 3 is disposed at the upper side, while the fixed cover 2 is disposed at the lower side.

The rotary tube 5 includes a step portion 35 formed at its central portion in a direction of its height, an annular portion 34 of a small height formed at the upper side of the step portion 35, a tubular portion 18 of a smaller diameter formed at an upper end of the annular portion 34, and a tubular wall 19 of a larger diameter formed at the lower side of the step portion 35. The step portion 35 abuts against a lower surface (outer surface) of the disk-like wall portion 28 of the bottom cover 4, and the annular portion 34 is rotatably engaged with an inner peripheral surface of the central hole 27. The upper tubular portion 18 passes through the hole 27 and a hole 12 of the ring plate 11, and is engaged with the inner surface of the inner peripheral wall 8 of the rotary cover 3, and is fixed to this inner surface. The lower tubular wall 19 serves as a turn canceller.

The ring plate 11 has an annular flat plate-like shape (More specifically, a peripheral step portion 48 of a small height is formed at a lower surface of the ring plate 11 such that a peripheral edge portion 49 of the hole 12 is slightly projected upwardly as shown in FIG. 2.). The ring plate 11 has one arc-shaped projecting piece portion 50 formed at the peripheral edge of the hole 12, and also has two notches 51 formed in the peripheral edge of the hole 12, one of the two notches 51 being disposed at the inner side of the projecting piece portion 50 while the other notch 51 is disposed in diametrically-opposite relation to the one notch 51, that is, circumferentially spaced an angle of 180 degrees therefrom.

A lower surface of the peripheral edge portion 49 of the hole 12 of the ring plate 11 is disposed in sliding contact with an annular projected portion 52 of the bottom cover 4 (which is formed at a peripheral edge portion of the hole 27) and the annular portion 34 of the rotary tube 5 in a common plane. An upper surface of the peripheral edge portion 49 abuts against distal end surfaces of annular walls 32 and 32′ of the inner peripheral wall 8 of the rotary cover 3. The ring plate 11 is held or gripped by distal end surfaces of the inner peripheral wall 8 and annular walls 32 and 32′ of the rotary cover 3, the annular projected portion 52 of the bottom cover 4 and the annular portion 34 of the rotary tube 5. The inner peripheral surface of the hole 12 of the ring plate 11 is disposed in intimate contact with the outer peripheral surface of the upper tubular wall 18 of the rotary tube 5, with substantially no gap formed therebetween.

The projecting piece portion 50 of the ring plate 11 is inserted and engaged in a recess (hole) 53 (FIG. 2) between the inner peripheral wall 8 and the annular wall 32′ of the rotary cover 3, and therefore is properly positioned relative thereto. Two pairs of projections 54 (FIG. 2), formed at the lower end of the inner peripheral wall 8 of the rotary cover 3, as well as projections 55 formed on the annular portion 34 of the rotary tube 5, are inserted and engaged respectively in the notches 51 of the ring plate 11 (Each projection 55 is inserted between the pair of projections 54.). As a result, the ring plate 11 is accurately positioned relative to the rotary cover 3 and the rotary tube 5, and also is retained (fixed) relative thereto against movement in the circumferential (peripheral) direction, and besides each notch 51 is closed by the corresponding projections 54 and projection 55, thereby enhancing the sealing of the inside of the covers.

As shown in FIG. 2 (which is a view as seen from the reverse side), a ring-like carrier 57 having a plurality of idler rollers 56 rotatably supported thereon, is placed on an outer peripheral portion of the upper surface of the ring plate 11. The carrier 57 includes an annular portion 58, and support shaft portions 59 projecting outwardly from the annular portion 58. The annular portion 58 is held in contact with the upper surface of the ring plate 11.

The idler rollers 56 are disposed within an annular space formed by the fixed cover 2 and the bottom cover 4 (FIG. 1), and the outer peripheral portions 37 of the flat harnesses 6 are disposed at the outer side of the idler rollers 56, while the inner peripheral portions 38 of the flat harnesses 6 are disposed at the inner side of the idler rollers 56.

Preferably, the ring plate 11 is made of a material with good sliding properties, such as polyacetal and PBT, in order to reduce sliding friction and sliding wear and also to enhance the rotation operability.

The two flat harnesses 6 (FIG. 1) include the respective portions (connecting portions) 16 which are to be connected to the terminals within the connector housing 15, respective straight portions 45 extending from the respective connecting portions 16 along the recessed groove (not shown) in the support wall 17 of the fixed cover 2, the respective outer peripheral portions (outer portions) 37 extending counterclockwise (in FIG. 1) from the respective straight portions 45 to make a circle with a large diameter, the respective inner peripheral portions (inner portions) 38 which are turned back (The turned-back portions are designated by reference numeral 39) from the respective outer peripheral portions 37, and extend clockwise to make a circle of a small diameter, and the respective portions (connecting portions) 41 (which are to be connected to the terminals within the connector housings 40 of the rotary cover 3) extending in an upstanding manner from the respective inner peripheral portions 38. Thus, the two flat harnesses 6 are formed into a generally annular shape or a generally spirally-wound shape.

In accordance with the rotation of the steering wheel (not shown), the rotary cover 3, the rotary tube 5 and the ring plate 11 are rotated in unison, and the inner peripheral portions 38 of the flat harnesses 6 are rotated together with the rotary cover 3. When the inner peripheral portions 38 of the flat harnesses 6 are rotated in a clockwise direction (in FIG. 1), the turned-back portions 39 are rotated together with the outer peripheral portions 37 in the same direction by an amount generally half of the amount of rotation of the inner peripheral portions 38, and also when the inner peripheral portions 38 are rotated in a counterclockwise direction, the turned-back portions 39 are rotated together with the outer peripheral portions 37 in the same direction by an amount generally half of the amount of rotation of the inner peripheral portions 38, thereby absorbing the rotation of the steering wheel.

The step portion 35 and annular portion 34 of the rotary tube 5 slides in the circumferential (peripheral) direction in contact with the peripheral edge of the hole 27 in the bottom cover 4, and therefore it is preferred to coat grease (not shown) on the step portion 35 and its vicinities for the purpose of reducing sliding friction (wear).

The lower surface of the ring plate 11 is held in intimate contact with the annular projected portion 52 of the bottom cover 4 (which is formed at the peripheral edge portion of the hole 27), so that a gap between the annular portion 34 of the rotary tube 5 and the inner periphery of the hole 27 is completely closed by the lower surface of the ring plate 11. Therefore, dust, wear powder, grease, etc., are positively prevented from intruding into the inside of the covers through this gap. The inner peripheral surface of the rotary tube 5 is sealed by a member (not shown) associated with the steering shaft, and therefore there is no fear that dust and so on intrude into the inside of the covers through the inner peripheral surface of the rotary tube 5.

The dust prevention effect of the ring plate 11 positively prevents troubles such for examples as a situation in which grease intrudes into a gap between the two flat harnesses to bond them together to thereby prevent the smooth bending/rotational motion of the flat harnesses and a situation in which dust and wear powder damage the flat harnesses.

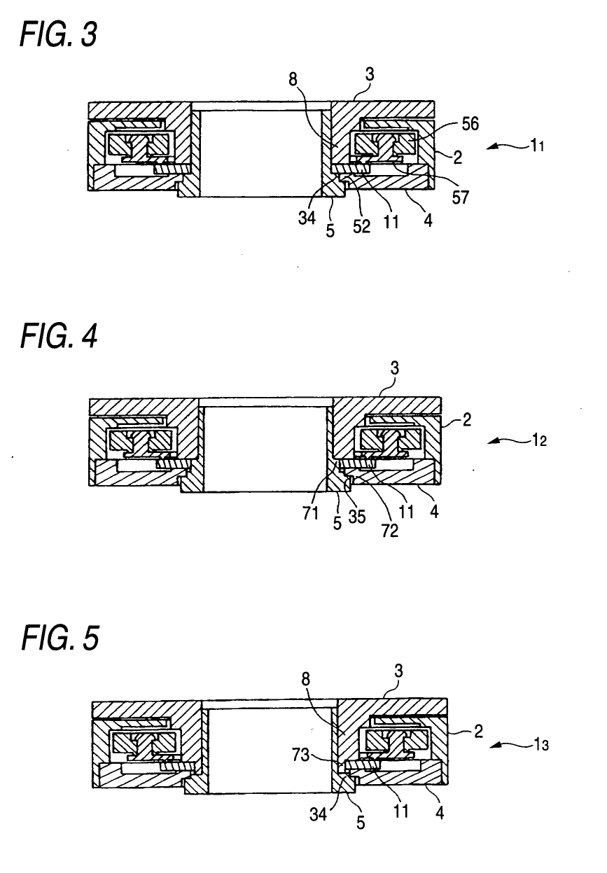

FIGS. 3 to 7 show various embodiments of rotary connector devices of the invention in which a ring plate 11 and the structure in its vicinities are suitably modified. In the following description, for convenience' sake, identical or corresponding members will be designated by identical reference numerals, respectively.

The rotary connector device 11 of FIG. 3 is similar to the rotary connector device of FIGS. 1 and 2, and an inner peripheral surface of a flat plate-like ring plate 11 is disposed in intimate contact with an outer peripheral surface of a rotary tube 5, and an upper surface of the ring plate 11 is held against a lower end surface of an inner peripheral wall 8 of a rotary cover 3, and a lower surface of the ring plate 11 is held against an upper surface of an annular portion 34 of the rotary tube 5, and is disposed in sliding contact with an annular projected portion 52 of a bottom cover 4 (which is formed on an upper surface thereof at a peripheral edge portion of a hole thereof). The rotary tube 5 is retainingly engaged with the rotary cover 3, and the ring plate 11 is held between (or gripped by) the rotary cover 3 and the rotary tube 5. An annular carrier 57, supporting rollers 56, is slidably mounted on the upper surface of the ring plate 11.

The rotary connector device 12 of FIG. 4 differs from the embodiment of FIG. 3 in that two step portions 35 and 71 are formed on a rotary tube 5 and that a lower surface of a ring plate 11 abuts against the upper step portion 71. The other construction is similar to that of the embodiment of FIG. 3. A step portion 72 formed at an inner periphery of a bottom cover 4 abuts against the lower step portion 35.

The rotary connector device 13 of FIG. 5 differs from the embodiment of FIG. 3 in that a step portion 73 is formed at an outer surface of an inner peripheral wall 8 of a rotary cover 3 at a lower end thereof, that an inner peripheral portion of a ring plate 11 is engaged with (abuts against) the step portion 73, and that the lower end of the inner peripheral wall 8 abuts against an annular portion 34 of a rotary tube 5. The other construction is similar to that of the embodiment of FIG. 3.

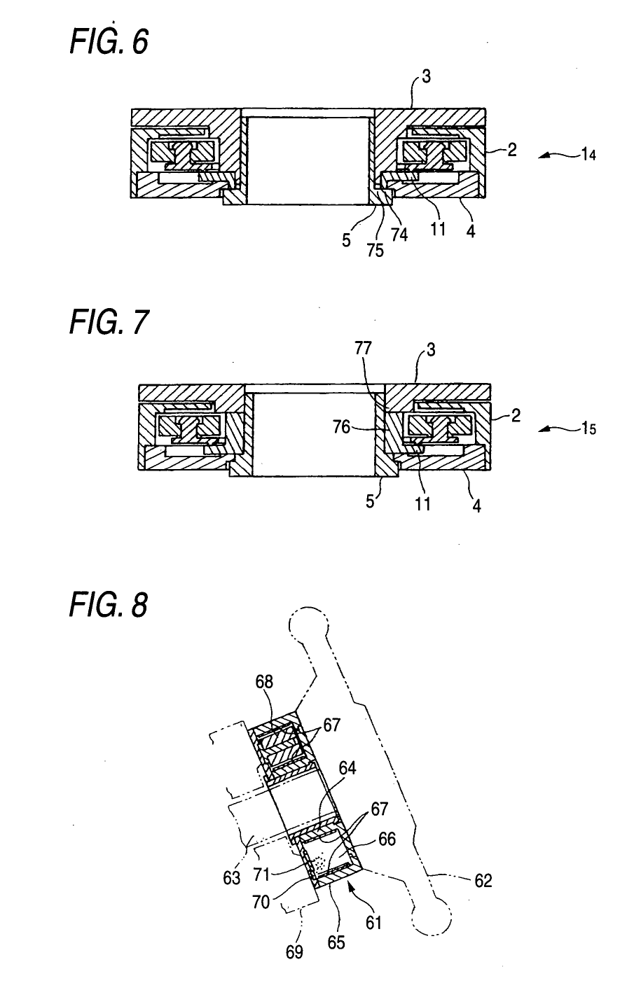

The rotary connector device 14 of FIG. 6 differs from the embodiment of FIG. 5 in that a downwardly-directed annular projected portion 74 is formed at an inner peripheral edge portion of a ring plate 11 and that a lower end of the annular projected portion 74 abuts against an annular flange portion (annular portion) 75 of a rotary tube 5. The other construction is similar to that of the embodiment of FIG. 5.

The rotary connector device 15 of FIG. 7 differs from the embodiment of FIG. 3 in that an upwardly-directed annular wall portion 76 is formed on an inner peripheral edge portion of a ring plate 11, that an inner peripheral surface of the annular wall portion 76 is disposed in contact with an outer peripheral surface of a rotary tube 5 and that an upper end surface of the annular wall portion 76 abuts against a lower end of a short inner peripheral wall 77 of a rotary cover 3. The other construction is similar to that of the embodiment of FIG. 3.

In any of the above embodiments, preferably, the ring plate 11 is held between (or gripped by) the rotary cover 3 and the rotary tube 5 to be fixed thereto, and with this construction it is not necessary to provide any separate fixing means for fixing the ring plate 11, and therefore the number of the component parts can be reduced, and also the structure can be formed into the simplified low-cost design.

Furthermore, in the above embodiments, the ring plate 11 is retainingly engaged with the rotary cover 3 by the upwardly-directed projecting piece portion 50, and also is retained by the downwardly-directed projections 54 of the rotary cover 3, and further is retained by the upwardly-directed projections 55 of the rotary tube 5 in a double manner. However, the ring plate 11 can be retainingly engaged only with the rotary cover 3 or with the rotary tube 5 by similar means.

Furthermore, in the above embodiments, the annular projected portion 52 is formed at the peripheral edge portion of the hole 27 in the bottom cover 4, and the annular projected portion 52 is held in sliding contact with the lower surface of the ring plate 11. However, the provision of the annular projected portion 52 can be omitted, in which case the inner (upper) surface of the inner peripheral portion (which defines the peripheral edge portion of the hole 27) of the disk-like wall portion 28 of the bottom cover 4 is directly held in sliding contact with the lower surface of the ring plate 11.

Furthermore, in the above embodiments, although the two flat harnesses 6 are used, more than two flat harnesses 6 or only one flat harness can be used, and in this case, also, the above dust prevention structure is effective.

Furthermore, in the above embodiments, the rotary connector device 1 is provided around the steering of the automobile, the rotary connector device 1 can be applied to other rotary portion than the steering so as to effect a power supply to the rotary portion, etc., while absorbing the rotation of the rotary portion.

What is claimed is:

1. A rotary connector device comprising:
a fixed cover;
a rotary cover rotatable relative said fixed cover;
a bottom cover fixed to said fixed cover;
a flat harness received within an annular space formed by said fixed cover, said rotary cover and said bottom cover; and
a rotary tube which passes through a hole formed through said bottom cover, and is fixed to said rotary cover;
wherein a dust prevention ring plate is provided so as to be disposed in intimate contact with an outer peripheral surface of said rotary tube and an inner peripheral edge of said hole of said bottom cover.

2. A rotary connector device according to claim 1, wherein said ring plate is held between an inner peripheral wall of said rotary cover and an annular portion of said rotary tube.

3. A rotary connector device according to claim 1, wherein said ring plate is retainingly engaged with at least one of said rotary cover and said rotary tube against movement relative thereto in a direction of a periphery of said ring plate.
